(19) United States
(12) Patent Application Publication
(10) Pub. No.: US 2025/0162188 A1
(43) Pub. Date: May 22, 2025

(54) WOOD TREATMENT COMPRISING PHOSPHATES

(71) Applicant: SWIMC LLC, Cleveland, OH (US)

(72) Inventors: Elio Morelli, Bologna (IT); Fredrik Ahlberg, Ydre (SE); Giampaolo Zilli, Bologna (IT); Ingvar LINDH, Bromma (SE)

(21) Appl. No.: 18/836,166

(22) PCT Filed: Sep. 8, 2022
(86) PCT No.: PCT/US2022/076094

§ 371 Date: Aug. 6, 2024

Related U.S. Application Data
(60) Provisional application No. 63/313,761, filed on Feb. 25, 2022.

(51) Int. Cl. B27K 3/52; B27K 3/16; B27K 3/22; B27K 5/02

(52) U.S. Cl. CPC B27K 3/52; B27K 3/166; B27K 3/22; B27K 5/02; B27K 2240/30

(57) ABSTRACT

The present application relates to an oil system used for wood treatment comprising: 1) at least one wood finish oil, and 2) at least one fire retardant comprising halogen phosphate, organic phosphate, organic phosphonate, or combinations thereof. The oil system may be at least partially impregnated into a substrate such as a wood or wood composite. Also describes is a method for preparing the oil system and an article containing the oil system described herein.

### FIELD

The present disclosure relates generally to relates to an oil system used for wood treatment comprising: 1) at least one wood finish oil, and 2) at least one fire retardant comprising halogen phosphate, organic phosphate, organic phosphonate, or combinations thereof. The oil system may be at least partially impregnated into a substrate such as a wood or other substrate. A method for preparing the oil system and an article containing the oil system are also disclosed.

### BACKGROUND

Wood is a widespread environmentally friendly, renewable natural resource and is important in a number of industrial sectors of the economy such as construction, furniture production, siding for structures, and flooring. It is aesthetically pleasing appearance has only increased its use over recent years. Wood is often protected in order to enhance its natural beauty and prevent it from physical damage, including but not limited to rotting, scratching, and external influences. One type of treatment includes the use of oil systems on wood and wood composites.

Certain conventional oil systems for wood contain oil, and these oil systems are impregnated into the wood, often using pressure and a vacuum to force the oil system deep into the wood. The oil system many be used to stabilize the dimensions of the wood, increase its resistance to water and chemicals, and reduce cracking. In essence, oil systems protect the wood and preserve its lifespan. However, the oil systems may be a source of inherent flammability and contribute to a faster and hotter burn of the wood after it has been exposed to fire as compared to untreated wood. Specifically, the oil impregnated wood burns heavier and faster than an untreated substrate, worsening the Fire Retardant Class rating to E. Presently, legislation and regulations are pushing for the reaction to fire of exterior building cladding to be equal or better than untreated wood, meaning without an oil system (i.e., D S2 d0 or better). While there are waterborne vacuum fire retardant treatments that may be used as an alternative to oil systems, they are not effective if there is a subsequent combustible oil impregnation.

In view of these challenges with many conventional systems, the need therefore remains for improved oil systems having a reaction to fire that is equal or better than untreated wood or wood composites that can provide a similar or better performance to traditional oil systems as well as other advantages.

### SUMMARY

The embodiments of what is described herein are not intended to be exhaustive or to limit what is provided in the claimed subject matter and disclosed in the detailed description. Rather, the embodiments are chosen and described so that others skilled in the art may appreciate and understand the principles and practices of what is provided in the claimed subject matter.

An oil system used for wood treatment is shown and described. The oil system may comprise: 1) at least one wood finish oil, and 2) at least one fire retardant comprising halogen phosphate, organic phosphate, organic phosphonate, or combinations thereof. At least one fire retardant may be at least partially soluble. The oil system may be at least partially impregnated into a substrate such as a wood or wood composite. A method for preparing the oil system described herein and an article containing the oil system described herein are also disclosed.

To the accomplishment of the foregoing and related ends, the following description set forth certain illustrative aspects and implementations. These are indicative of a few of the various ways in which one or more aspects may be employed. Other aspects, advantages and novel features of the disclosure will become apparent from the following detailed description when considered.

### DETAILED DESCRIPTION

Aspects of what is described herein are disclosed in the following description related to specific embodiments. Alternative embodiments may be devised without departing from the scope of what is described herein. Additionally, well-known embodiments of what is described herein may not be described in detail or will be omitted so as to not obscure the relevant details of what is described herein. Further, to facilitate an understanding of the description, discussion of several terms used herein follows.

As used herein, the word “exemplary” means “serving as an example, instance, or illustration.” The embodiments described herein are not limiting, but rather exemplary only. It should be understood that the described embodiments are not necessarily to be construed as preferred or advantageous over other embodiments. Moreover, the term “embodiment(s)” does not require that all embodiments include the discussed feature, advantage, or mode of operation.

The present disclosure relates generally to oil systems that provide advantageous improvements over current oil systems. It has been discovered that the use of a particular oil system comprising: 1) at least one wood finish oil, and 2) at least one fire retardant comprising halogen phosphate, organic phosphate, organic phosphonate, or combinations thereof can surprisingly lead to improved performance properties when used in an oil system, namely similar or improved flame retardancy, dimensional stability, and durability as well as other advantages. Further, it has been discovered that the oil system described herein provides improved fire retardancy over conventional oil systems. These conventional oil systems may comprise natural oils such as linseed oil and other more processed oils such as napthenic oil. In addition, it has been discovered that the oil system described herein provides fire retardancy performance similar to that of untreated wood.

In many embodiments, the oil system described herein may have a Fire Class D rating on Royal impregnated panels. For the Royal impregnated process for panels, also known as the Royal Oils Treatment, the wood subjected to a hot oil treatment under vacuum. In many embodiments, the wood may be subjected to the vacuum for about three hours. In some embodiments, the wood may be preserved with a preservative system prior to the hot oil treatment under vacuum. Royal impregnated and treated wood products may be used for exterior applications due to high dimensional stability and durability (like outdoor building products) or interior applications (like flooring and furniture). It has been found that using the oil system described herein in place of a conventional hot oil treatment like that used in the Royal impregnation process improves the fire retardancy of wood.

In many embodiments, the oil system comprises at least one wood finish oil. In some embodiments, at least one wood finish oil comprises linseed oil, tung oil, teak oil, or combinations thereof. In other embodiments, at least one wood finish oil may be sunflower oil. In another embodiments, at least one wood finish oil may be safflower oil. In another embodiments, at least one wood finish oil may be rapeseed oil. In yet another embodiment, at least one wood finish oil may be walnut oil. In further embodiments, at least one wood finish oil may be danish oil. Other types of wood finish oil are also contemplated. In one embodiment, at least one wood finish oil may be raw, meaning in its natural form with minimal processing. In other embodiments, at least one wood finish oil may be polymerized by heating it in the absence of oxygen. In yet other embodiments, at least one wood finish oil may be boiled, meaning that at least one drying agent is added to the wood finish oil. In one embodiment, at least one wood finish oil may be a modified oil such as a maleinised oil.

In many embodiments, at least one wood finish oil is 20% to 80% by weight of the oil system described herein. In other embodiments, at least one wood finish oil of the oil system described herein can, for example range from 25% to 75% by weight, from 30% to 75% by weight, from 25% to 70% by weight, from 30% to 70% by weight, from 30% to 65% by weight, from 30% to 60% by weight, from 30% to 55% by weight, from 30% to 50% by weight, from 35% to 75% by weight, from 35% to 70% by weight, from 35% to 65% by weight, from 35% to 60% by weight, from 35% to 55% by weight, from 35% to 50% by weight, from 35% to 45% by weight, from 40% to 75% by weight, from 40% to 70% by weight, from 40% to 65% by weight, from 40% to 60% by weight, from 40% to 55% by weight, and from 40% to 50% by weight. Other weight ranges are also contemplated.

In some embodiments, at least one wood finish oil further comprises at least one solvent. In some embodiments, at least one solvent may be an organic solvent. In other embodiments, at least one solvent may be an inorganic solvent. Examples of organic solvent may include but are not limited to organic acetates, mineral spirits, organic ethers, ketones, or combinations thereof. In one embodiment, the organic solvent is methyl acetate. In one embodiment, the organic solvent is ethyl acetate. In another embodiment, the organic solvent is a glycol ether. In yet another embodiment, the organic solvent is ethylene glycol monobutyl ether. In some embodiments, the ketone is acetone, methylethyl ketone, methyl isobutyl ketone, di-isobutyl ketone, diacetone alcohol, or combinations thereof. In one embodiment, the organic solvent is naphthenic oil. In one embodiment, the organic solvent is high boiling (over 160° C.) naphthenic oil. Other solvents are also contemplated. In many embodiments, at least one solvent has a boiling point greater than 125° C., for example be greater than 130° C., greater than 135° C., greater than 140° C., greater than 145° C., greater than 150° C., greater than 155° C., greater than 160° C., greater than 165° C., and greater than 170° C. Lower boiling points are also contemplated.

The oil system described herein also comprises at least one fire retardant. In many embodiments, at least one fire retardant comprising halogen phosphate, organic phosphate, organic phosphonate, or combinations thereof is at least partially soluble in the oil system. In one embodiment, at least one fire retardant comprising halogen phosphate, organic phosphate, organic phosphonate, or combinations thereof is substantially soluble in the oil system. In some embodiments, at least one fire retardant is a phosphate triester, phosphate diester, or combinations thereof. In many embodiments, at least one fire retardant is triphenyl phosphate (TPhP), tricresylphosphate (TCP), tris(2-chloroethyl)phosphate (TCEP), tris(chloropropyl)phosphate (TCPP), tris (2-chloropropanol) phosphate, tris(1,3-dichloro-2-propyl)phosphate (TDCPP), tetrekis(2-chlorethyl)dichloroisopentyldiphosphate (V6), or combinations thereof. In one embodiment, the phosphate triester is tris (2-chloropropanol) phosphate. Other fire retardants, including other phosphate triesters, phosphate diesters, or combinations thereof, are also contemplated.

In many embodiments, at least one fire retardant is 20% to 80% by weight of the oil system described herein. In other embodiments, at least one fire retardant of the oil system described herein can, for example range from 25% to 75% by weight, from 30% to 75% by weight, from 25% to 70% by weight, from 30% to 70% by weight, from 30% to 65% by weight, from 30% to 60% by weight, from 30% to 55% by weight, from 30% to 50% by weight, from 35% to 75% by weight, from 35% to 70% by weight, from 35% to 65% by weight, from 35% to 60% by weight, from 35% to 55% by weight, from 35% to 50% by weight, from 35% to 45% by weight, from 40% to 75% by weight, from 40% to 70% by weight, from 40% to 65% by weight, from 40% to 60% by weight, from 40% to 55% by weight, and from 40% to 50% by weight. Other weight ranges are also contemplated.

Additionally, the oil system described herein may further comprise at least one inert oil. In one embodiment, at least one inert oil is naphthenic oil. In another embodiment, at least one inert oil is a parrafinic oil. Other inert oils are also contemplated. In many embodiments, at least one inert oil is 0% to 50% by weight of the oil system described herein. In other embodiments, at least one inert oil of the oil system described herein can, for example range from 1% to 50% by weight, from 5% to 50% by weight, from 10% to 50% by weight, from 20% to 50% by weight, from 5% to 45% by weight, from 5% to 40% by weight, from 5% to 35% by weight, from 5% to 30% by weight, from 10% to 45% by weight, from 10% to 40% by weight, from 10% to 35% by weight, from 10% to 30% by weight, from 15% to 50% by weight, from 15% to 45% by weight, from 15% to 40% by weight, from 15% to 35% by weight, from 15% to 30% by weight, from 20% to 45% by weight, from 20% to 40% by weight, from 20% to 35% by weight, and from 20% to 30% by weight. Other weight ranges are also contemplated.

The oil system described herein may further comprise at least one organic solvent. In many embodiments, at least one organic solvent comprises at least one alcohol, at least one aromatic compound, at least one ester, at least one ether, at least one ketone, at least one amine, at least one nitrated hydrocarbon, at least one halogenated hydrocarbon, at least one aliphatic compound, or combinations thereof.

In addition, the oil system described herein may further comprise at least one pigment. In some embodiments, at least one pigment may be a pigment that is at least partially dispersed in an organic solvent. In one embodiment, at least one pigment is red phosphorous. In another embodiment, at least one pigment is iron oxide, azodicarbonamide, expandable graphite, melamine, melamine cyanurate, or combinations thereof. In many embodiments, at least one pigment is at least partially dispersed in at least one alcohol, at least one aromatic compound, at least one ester, at least one ether, at least one ketone, at least one amine, at least one nitrated hydrocarbon, at least one halogenated hydrocarbon, or combinations thereof.

As described herein, oil system comprising: 1) at least one wood finish oil, and 2) at least one fire retardant comprising halogen phosphate, organic phosphate, organic phosphonate, or combinations thereof may be at least partially impregnated into a substrate using a vacuum. In some embodiments, pressure may also be used to impregnate the substrate with the oil system. In other embodiments, the oil system may be heated prior to at least partially impregnating a substrate. In some embodiments, the substrate may be heated in order to remove any moisture, typically water, from the substrate, leaving the oil system within the substrate. In some embodiments, the oil system may be heated to at least 65° C. In one embodiment, the oil system may be heated to at least 100° C. In another embodiment, the oil system may be heated to at least 150° C. In yet another embodiment, the oil system may be heated to at least 200° C. In some embodiments, the oil system may be heated to 65° C. to 250° C. In other embodiments, the oil system may be heated to 100° C. to 250° C. In yet other embodiments, the oil system may be heated to 150° C. to 250° C. In one embodiment, the oil system may be heated to 200° C. to 250° C. The heating may be done in a controlled manner in order to achieve a specific moisture content. In some embodiments, the moisture content of the substrate may be less than 50% moisture after heating. In another embodiment, the moisture content of the substrate may be less than 40% moisture after heating. In yet another embodiment, the moisture content of the substrate may be less than 30% moisture after heating. In one embodiment, the moisture content of the substrate may be less than 20% moisture after heating. In another embodiment, the moisture content of the substrate may be less than 15% moisture after heating. In a particular embodiment, the moisture content of the substrate may be 10% to 40% moisture after heating. In another embodiment, the moisture content of the substrate may be 10% to 30% moisture after heating. In one embodiment, the moisture content of the substrate may be 10% to 20% moisture after heating.

In another embodiment, any excess of the oil system may be removed from the substrate by vacuum.

In many embodiments, the substrate is a wood or wood composite. Other substrates besides wood and wood composites are also contemplated. In some embodiments, the wood is pine, spruce, oak, hickory, teak, maple, beech, walnut, mahogany, ash, birch, cherry, beech, cedar, acacia, eucalyptus, rubberwood, bamboo, or combinations thereof. Other species of wood are also contemplated. Wood composites may be a range of derivative wood products that are created by binding portions of the wood (like strands, powders/flour, fibers, and the like) together with at least one other component. At least one other component may include, but are not limited to, plastics, adhesives, fillers, pigments, additives, or combinations thereof. Wood composites are also known as engineered wood and are created to represent a desired end product. Examples of wood composites may include, but are not limited to, fiberboard (for example, medium density fiberboard), plywood, oriented strand board, hardboard, and wood-plastic composites. In one embodiment, straw such as barley straw, oat straw, rye straw, wheat straw, rice straw, or combinations thereof may be used instead of or in conjunction with wood and wood composites.

In one embodiment, the wood is thermally treated. In another embodiment, the wood is acetylated. In yet another embodiment, the wood may be both thermally treated and acetylated. In one embodiment, the wood may be steam treated. Other wood treatments may also be considered.

In some embodiments, the substrate is impregnated with water soluble nitrogen and at least one phosphate-containing substance prior to the oil system being at least partially impregnated. In some embodiments, the water soluble nitrogen comprises urea. In one particular embodiment, the at least one phosphate-containing substance comprises ammonium salts of phosphoric acid. In another embodiment, the at least one phosphate-containing substance comprises sodium salts of phosphoric acid. In yet another embodiment, the at least one phosphate-containing substance comprises potassium salts of phosphoric acids. Other alkaline salts are also contemplated. In one embodiment, the substrate is impregnated with water and copper prior to the water soluble nitrogen and at least one phosphate-containing substance being impregnated.

In many embodiments, the substrate is at least partially impregnated with at least one waterborne copper salt solution prior to the oil system being at least partially impregnated. The waterborne copper salt solution is water soluble. With the addition of at least one waterborne copper salt solution, the oil system described herein may provide both wood protection and fire retardant performance.

In many embodiments, at least one waterborne copper salt solution comprises bis-(n-cyclohexyldiazeniumdioxy)-copper, copper (II) carbonate hydroxide, or combinations thereof. Other copper salts are also contemplated.

In many embodiments, the at least one waterborne copper salt solution is solubilized with water, urea, diammoniumhydrogen phosphate (DAP), or combinations thereof. Other liquids for solubilizing are also contemplated. In some embodiments, the liquids may be a solution.

In many embodiments, at least one waterborne copper salt solution that is solubilized and used with the oil system described herein may provide a Fire Class E rating as defined below in Table 1. In some embodiments, at least one waterborne copper salt solution that is solubilized and used with the oil system described herein may provide a Fire Class D rating. In another embodiment, at least one waterborne copper salt solution that is solubilized and used with the oil system described herein may provide a Fire Class C rating. In some embodiments, the substrate which is at least partially impregnated with at least one waterborne copper salt solution that is solubilized and used prior to the oil system being at least partially impregnated may have a Fire Class C, a smoke class of s3, and a droplet class dO according to Reaction to Fire EN 13501 with Fire testing EN13823 (SB1) and EN 150 11925-2 (small flame), which is further described below in Table 1.

In many embodiments, at least one copper salt is 0.3% to 5.0% by weight of the waterborne copper salt solution. In other embodiments, at least one copper salt of the waterborne copper salt solution described herein can, for example range from 0.3% to 4.5% by weight, from 0.3% to 4.0% by weight, from 0.3% to 3.5% by weight, from 0.3% to 3.0% by weight, from 0.3% to 2.5% by weight, from 0.3% to 2.0% by weight, from 0.5% to 5.0% by weight, from 0.5% to 4.5% by weight, from 0.5% to 4.0% by weight, from 0.5% to 3.5% by weight, from 0.5% to 3.0% by weight, from 0.5% to 2.5% by weight, from 0.5% to 2.0% by weight, from 0.7% to 5.0% by weight, from 0.7% to 4.5% by weight, from 0.7% to 4.0% by weight, from 0.7% to 3.5% by weight, from 0.7% to 3.0% by weight, from 0.7% to 2.5% by weight, from 0.7% to 2.0% by weight, from 1.0% to 5.0% by weight, from 1.0% to 4.5% by weight, from 1.0% to 4.0% by weight, from 1.0% to 3.5% by weight, from 1.0% to 3.0% by weight, from 1.0% to 2.5% by weight, from 1.0% to 2.0% by weight, from 1.3% to 5.0% by weight, from 1.3% to 4.5% by weight, from 1.3% to 4.0% by weight, from 1.3% to 3.5% by weight, from 1.3% to 3.0% by weight, from 1.3% to 2.5% by weight, from 1.3% to 2.0% by weight, from 1.5% to 5.0% by weight, from 1.5% to 4.5% by weight, from 1.5% to 4.0% by weight, from 1.5% to 3.5% by weight, from 1.5% to 3.0% by weight, from 1.5% to 2.5% by weight, and from 1.5% to 2.0% by weight. Other weight ranges are also contemplated.

In another embodiment, the oil system described herein is particularly suitable in the preparation of other substrates, including but not limited to at least partially porous substrates like plastics, ceramics, cement, composites, paper, polymers (including films), plaster, metals, or combinations thereof.

Further, the substrate with the oil system described herein has improved fire retardant performance. The substrate with the oil system may be tested to determine the reaction to fire behavior of building products when exposed to a thermal attack by a single burning item. The Fire Growth Rate Index may be used to quantify the fire retardant performance as shown below in Table 1.

TABLE 1
European Fire Class Requirements

| | | | According to: | | | | |
|---|---|---|---|---|---|---|---|
| Fire | Smoke | Droplet | Non- | | Small | FIGRA | |
| Class | Class | Class | Combustible | SBI | Flame | (W/s) | Examples |
| A1 | — | — | X | — | — | — | Stone |
| A2 | s1-s3 | d0-d2 | X | X | | ≤120 | Gypsum boards, thin paper, |
| | | | | | | | mineral wool |
| B | s1-s3 | d0-d2 | — | X | X | ≤120 | Gypsum boards, thick |
| | | | | | | | paper, fire retardant wool |
| C | s1-s3 | d0-d2 | — | X | X | ≤250 | Wallpaper on Gypsum |
| | | | | | | | boards, fire retardant wool |
| D | s1-s3 | d0-d2 | — | X | X | ≤750 | Wood Paneling and Wood- |
| | | | | | | | based Panels |
| E | — | d2 | — | — | X | — | |
| F | — | — | — | — | X | — | |

In some embodiments, the substrate with the oil system has a Fire Growth Rate Index (FIGRA) value using the Single Burning Item (SBI) method according to EN 13823-2020 of 750 W/s or less. In another embodiment, the substrate with the oil system has a FIGRA value using Cone calorimetry method according to EN 13823-2020 of 650 W/s or less. Lower FIGRA values are also contemplated.

Also provided is a method of preparing the oil system described herein. Specifically, a method of preparing the oil system comprising: 1) at least one wood finish oil, and 2) at least one fire retardant comprising halogen phosphate, organic phosphate, organic phosphonate, or combinations thereof.

Further provided is an article comprising: 1) a substrate having at least one surface; and 2) the oil system comprising: 1) at least one wood finish oil, and 2) at least one fire retardant comprising halogen phosphate, organic phosphate, organic phosphonate, or combinations thereof at least partially coated on the at least one substrate, wherein the substrate comprises wood, metal, glass, plastic, paper, leather, fabric, ceramic, or any combination thereof. In many embodiments, the substrate is a wood or wood composite. In some embodiments, the wood is pine, spruce, oak, hickory, teak, maple, beech, walnut, mahogany, ash, birch, cherry, beech, cedar, acacia, eucalyptus, rubberwood, bamboo, or combinations thereof. Other species of wood are also contemplated. Wood composites may be a range of derivative wood products that are created by binding portions of the wood (like strands, powders/flour, fibers, and the like) together with at least one other component. At least one other component may include, but are not limited to, plastics, adhesives, fillers, pigments, additives, or combinations thereof. Wood composites are also known as engineered wood and are created to represent a desired end product. Examples of wood composites may include, but are not limited to, fiberboard (for example, medium density fiberboard), plywood, oriented strand board, hardboard, and wood-plastic composites. In one embodiment, straw such as barley straw, oat straw, rye straw, wheat straw, rice straw, or combinations thereof may be used instead of or in conjunction with wood and wood composites. In many embodiments, at least one coating is further applied to the substrate. In some embodiments, at least one coating is a solvent borne coating. In other embodiments, at least one coating is a waterborne coating.

### Test Results

Samples of Fire Retardant oil systems were prepared in with vacuum and high pressure equipment and results are given in FIG. 2 below by Cone calorimetry method according to EN 13823-2020 for FIGRA. If the actual FIGRA test was completed, then Single Burning Item (SBI) method according to EN 13823-2020 was used.

TABLE 2
FIGRA Results

| | Cone Predicted FIGRA |
|---|---|
| | (in (W/s)) |
| Sample | (Actual Test if completed) |
| Royal Fresh | 2670 |
| Royal 6 month | 1947 |
| Royal 18 month | 1618 |
| Untreated Cladding without Fire Retardant | 769 |
| Untreated Cladding 50% Fire Retardant | 1123 |
| Untreated Cladding 25% Fire Retardant | 1598 (1772) |
| Oil System Cladding with 50% Fire | 500 |
| Retardant - 1^{st} repetition | |
| Oil System Cladding with 50% Fire | 970 |
| Retardant - 2^{nd} repetition | |
| Oil System Cladding with 50% Fire | 933 |
| Retardant - 3^{rd} repetition | |

As provided above in Table 2, a conventional oil treatment without a fire retardant (like Royal treated wood cladding above) has an increased FIGRA as compared to untreated wood both with and without fire retardant. As the fire retardant concentration increases in untreated cladding, the burning of the wood, as provided by the FIGRA value, decreases. However, using the oil system with the fire retardant described herein protects the wood and also reduces the FIGRA value, meaning the fire growth is reduced. The oil system described herein provides unexpectedly better fire retardancy than Royal treated wood. The oil system described herein may provide similar FIGRA results than untreated wood either with or without fire retardant. In some instances, the oil system described herein may provide better FIGRA results than untreated wood either with or without fire retardant.

In addition, further testing was also done in the Royal Oils Treatment process (described above and also abbreviated as Royal) in the first water Cu (II) vacuum/high pressure steps using water soluble nitrogen containing substances and phosphate salt to impregnate the water based pretreatment. For the second stage of the process, an oil treatment is completed. Results for the various formulations of the oil treatment described herein are provided in Table 3 below, with both FIGRA and Smoke results completed using Single Burning Item (SBI) method according to EN 13823-2020. The Class Rating has also been previously provided in Table 1.

TABLE 3
Cone Calorimetry data of first with FR in water step treatment
followed by oil treatment on Impregnated Pine

| | | | Class Rating |
|---|---|---|---|
| Example | FIGRA | Smoke (m²) | (Fire class & Smoke class) |
| 1 | 775.72 | 141.1846 | E s2 |
| 2 | 541.26 | 100.036 | D s2 |
| 3 | 733.42 | 145.5712 | D s2 |
| 4 | 675.60 | 110.3496 | D s2 |
| 5 | 649.08 | 188.8482 | D s2 |
| 6 | 553.88 | 108.3273 | D s2 |
| 7 | 530.15 | 145.2341 | D s2 |
| 8 | 517.27 | 150.8628 | D s2 |

As provided in Table 3, the samples of the oil system with the fire retardant described herein provides a significant reduction of the FIGRA values of typical oil systems without fire retardant.

### Embodiments

The following embodiments are contemplated. All combinations of features and embodiments are contemplated.

Embodiment 1: An oil system comprising: 1) at least one wood finish oil, and 2) at least one fire retardant comprising halogen phosphate, organic phosphate, organic phosphonate, or combinations thereof.

Embodiment 2: An embodiment of Embodiment 1, wherein at least one wood finish oil comprises linseed oil, tung oil, teak oil, or combinations thereof.

Embodiment 3: An embodiment of any of Embodiments 1-2, wherein at least one wood finish oil further comprises at least one solvent.

Embodiment 4: An embodiment of any of Embodiments 1-3, wherein the at least one fire retardant comprising halogen phosphate, organic phosphate, organic phosphonate, or combinations thereof is at least partially soluble.

Embodiment 5: An embodiment of any of Embodiments 1-3, wherein at least one fire retardant is a phosphate triester, phosphate diester, or combinations thereof.

Embodiment 6: An embodiment of Embodiment 5, wherein the phosphate triester is tris (2-chloropropanol) phosphate.

Embodiment 7: An embodiment of any of Embodiments 1-6 further comprising at least one inert oil.

Embodiment 8: An embodiment of Embodiment 7, wherein at least one inert oil is naphthenic oil.

Embodiment 9: An embodiment of any of Embodiments 1-8 further comprising at least one organic solvent.

Embodiment 10: An embodiment of any of Embodiments 1-9 further comprising at least one pigment.

Embodiment 11: An embodiment of any of Embodiments 1-10, wherein the oil system is at least partially impregnated into a substrate using a vacuum.

Embodiment 12: An embodiment of Embodiment 11, wherein the substrate is a wood or wood composite.

Embodiment 13: An embodiment of Embodiment 12, wherein the wood is pine, spruce, oak, hickory, teak, maple, beech, walnut, mahogany, ash, birch, cherry, beech, cedar, acacia, eucalyptus, rubberwood, bamboo, or combinations thereof.

Embodiment 14: An embodiment of Embodiment 12, wherein the wood is thermally treated

Embodiment 15: An embodiment of Embodiment 12, wherein the wood is acetylated.

Embodiment 16: An embodiment of any of Embodiments 11-15, wherein the substrate is impregnated with water soluble nitrogen and at least one phosphate-containing substance prior to the oil system being at least partially impregnated.

Embodiment 17: An embodiment of Embodiment 16, wherein the water soluble nitrogen comprises urea.

Embodiment 18: An embodiment of any of Embodiments 16-17, wherein the at least one phosphate-containing substance comprises ammonium salts of phosphoric acid.

Embodiment 19: An embodiment of any of Embodiments 16-18, wherein the substrate is impregnated with water and copper prior to the water soluble nitrogen and at least one phosphate-containing substance being impregnated.

Embodiment 20: An embodiment of any of Embodiments 11-15, wherein the substrate is at least partially impregnated with at least one waterborne copper salt solution prior to the oil system being at least partially impregnated.

Embodiment 21: An embodiment of Embodiment 20, wherein the at least one waterborne copper salt solution comprises bis-(n-cyclohexyldiazeniumdioxy)-copper, copper (II) carbonate hydroxide, or combinations thereof.

Embodiment 22: An embodiment of any of Embodiments 20-21, wherein the at least one waterborne copper salt solution is solubilized with water, urea, diammoniumhydrogen phosphate (DAP), or combinations thereof.

Embodiment 23: An embodiment of any of Embodiments 1-22, wherein the substrate with the oil system has a FIGRA value using SBI method according to EN 13823-2020 of 750 W/s or less.

Embodiment 24: An embodiment of any of Embodiments 1-22, wherein the substrate with the oil system has a FIGRA value using Cone calorimetry method according to EN 13823-2020 of 650 W/s or less.

Embodiment 25: A method of preparing the oil system of any of Embodiments 1-24.

Embodiment 26: An article comprising: 1) a substrate having at least one surface; and 2) the oil system of any of Embodiments 1-24 at least partially coated on the at least one substrate; wherein the substrate comprises wood, metal, glass, plastic, paper, leather, fabric, ceramic, or any combination thereof.

What has been described above includes examples of the claimed subject matter. All details and any described modifications in connection with the Background and Detailed Description are within the spirit and scope of the claimed subject matter will be readily apparent to those of skill in the art. In addition, it should be understood that aspects of the claimed subject matter and portions of various embodiments and various features recited below and/or in the appended claims may be combined or interchanged either in whole or in part. In the foregoing descriptions of the various embodiments, those embodiments which refer to another embodiment may be appropriately combined with other embodiments as will be appreciated by one of skill in the art. Furthermore, those of ordinary skill in the art will appreciate that the foregoing description is by way of example only, and is not intended to limit the claimed subject matter, realizing that many further combinations and permutations of the claimed subject matter are possible. It is, of course, not possible to describe every conceivable combination of components or methodologies for purposes of describing the claimed subject matter, but one of ordinary skill in the art may recognize. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An oil system comprising:
at least one wood finish oil; and
at least one fire retardant comprising halogen phosphate, organic phosphate, organic phosphonate, or combinations thereof.

2. The oil system of claim 1, wherein at least one wood finish oil comprises linseed oil, tung oil, teak oil, or combinations thereof.

3. The oil system of claim 1, wherein at least one wood finish oil further comprises at least one solvent.

4. The oil system of claim 1, wherein the at least one fire retardant comprising halogen phosphate, organic phosphate, organic phosphonate, or combinations thereof is at least partially soluble.

5. The oil system of claim 1, wherein at least one fire retardant is a phosphate triester, phosphate diester, or combinations thereof.

6. The oil system of claim 5, wherein the phosphate triester is tris (2-chloropropanol) phosphate.

7. The oil system of claim 1 further comprising at least one inert oil.

8. The oil system of claim 7, wherein at least one inert oil is naphthenic oil.

9. The oil system of claim 1 further comprising at least one organic solvent.

10. The oil system of claim 1 further comprising at least one pigment.

11. The oil system of claim 1, wherein the oil system is at least partially impregnated into a substrate using a vacuum.

12. The oil system of claim 11, wherein the substrate is a wood or wood composite.

13. The oil system of claim 12, wherein the wood is pine, spruce, oak, hickory, teak, maple, beech, walnut, mahogany, ash, birch, cherry, beech, cedar, acacia, eucalyptus, rubberwood, bamboo, or combinations thereof.

14. The oil system of claim 12, wherein the wood is thermally treated.

15. The oil system of claim 12, wherein the wood is acetylated.

16. The oil system of claim 11, wherein the substrate is impregnated with water soluble nitrogen and at least one phosphate-containing substance prior to the oil system being at least partially impregnated.

17. The oil system of claim 16, wherein the water soluble nitrogen comprises urea.

18. The oil system of claim 16, wherein the at least one phosphate-containing substance comprises ammonium salts of phosphoric acid.

19. The oil system of claim 16, wherein the substrate is impregnated with water and copper prior to the water soluble nitrogen and at least one phosphate-containing substance being impregnated.

20. The oil system of claim 11, wherein the substrate is at least partially impregnated with at least one waterborne copper salt solution prior to the oil system being at least partially impregnated.

21. The oil system of claim 20, wherein the at least one waterborne copper salt solution comprises bis-(n-cyclohexyldiazeniumdioxy)-copper, copper (II) carbonate hydroxide, or combinations thereof.

22. The oil system of claim 20, wherein the at least one waterborne copper salt solution is solubilized with water, urea, diammoniumhydrogen phosphate (DAP), or combinations thereof.

23. The oil system of claim 1, wherein the substrate with the oil system has a FIGRA value using SBI method according to EN 13823-2020 of 750 W/s or less.

24. The oil system of claim 1, wherein the substrate with the oil system has a FIGRA value using Cone calorimetry method according to EN 13823-2020 of 650 W/s or less.

25. A method of preparing the oil system of claim 1.

26. An article comprising:
a substrate having at least one surface; and
the oil system of claim 1 at least partially coated on the at least one substrate;
wherein the substrate comprises wood, metal, glass, plastic, paper, leather, fabric, ceramic, or any combination thereof.
